(19) United States
(12) Patent Application Publication
(10) Pub. No.: US 2012/0191873 A1
(43) Pub. Date: Jul. 26, 2012

(54) RELAY APPARATUS, COMMUNICATION NETWORK SYSTEM, AND LOAD DISTRIBUTION METHOD

(75) Inventors: Masato Himeno, Osaka (JP); Fuminori Kimura, Yokohama (JP)

(73) Assignee: Hitachi, Ltd.

(21) Appl. No.: 13/223,864

(22) Filed: Sep. 1, 2011

(30) Foreign Application Priority Data
Jan. 25, 2011 (JP) 2011-13077

(51) Int. Cl. G06F 15/173

(52) U.S. Cl. 709/242

(57) ABSTRACT

In a network where a plurality of large-scale network address translation (LSN) devices are disposed, a relay apparatus acquires the numbers of sessions held by the plurality of LSN devices in the network and allocates a packet received from a subscriber to the LSN device holding the smallest number of sessions or to the LSN device having a fewer number of sessions than a predetermined threshold, thereby distributing subscriber sessions evenly to the plurality of LSN devices.

### CLAIM OF PRIORITY

The present application claims priority from Japanese patent application JP 2011-013077 filed on Jan. 25, 2011, the content of which is hereby incorporated by reference into this application.

### BACKGROUND OF THE INVENTION

1. Field of the Invention

The present invention relates to relay apparatuses, communication network systems, and load distribution methods, and more specifically, to a relay apparatus that relays communication in a network system using LSN, a related communication network system, and a load distribution method that distributes session loads.

2. Description of the Related Art

The pool of unallocated Internet Protocol Version 4 (IPv4) addresses has been running out in recent years. Exhaustion of IPv4 addresses is predicted to occur around 2011 or 2012.

As one solution to the exhaustion of IPv4 addresses, large-scale network address translation (LSN) is under study (Non-Patent Document 1). LSN allocates a single global address to a plurality of subscribers by performing network address translation (NAT) at an aggregation point of the Fiber to the home (FTTH) or asymmetric digital subscriber line (ADSL) provided by a communications carrier.

One feature of LSN is that NAT, which used to be carried out on a small scale with respect to customer premises equipment, is carried out on a large scale in a network system provided by the communications carrier.

Patent Document 1 describes a router setting method that performs load distribution by default router distribution, giving consideration to loads on routers, without adding a modification to existing communications terminals or DHCP servers.

Patent Document 1: Japanese Unexamined Patent Application Publication No. 2003-348136

Non-Patent Document 1: Internet Draft, Common requirements for IP address sharing schemes

### SUMMARY OF THE INVENTION

FIG. 1 shows a conventional network configuration diagram.

Conventionally, an LSN device 102 (FIG. 1) is placed in a network system 101 (FIG. 1) of a communications carrier, at a connection point to another communications carrier or a connection point to a global address space. A packet that is originated from a subscriber or addressed to a subscriber is transferred through a relay network 103 (FIG. 1) of the communications carrier to the LSN device 102 (FIG. 1) or to the subscriber premises 105 (FIG. 1), in accordance with routing tables of equipment, which have been generated dynamically by a routing protocol or the like or statically by the maintenance operator. The LSN device 102 (FIG. 1) performs a NAT process in accordance with the header of the received packet and a NAT session table in the LSN device 102 (FIG. 1).

If a plurality of LSN devices 102 (FIG. 1) are placed, since the LSN devices 102 (FIG. 1) perform the NAT process on subscribers' packets on the basis of the routing tables of the equipment in the network system and since the number of sessions used by each subscriber changes dynamically, it is usually difficult to distribute sessions held by the LSN devices 102 (FIG. 1) evenly.

Patent Document 1 describes that each router should have a function to exchange the current load status of the packet transfer function among a plurality of routers and have means for recognizing a router with the lowest load among the routers, which connect two networks. In addition, the communications terminals must broadcast a DHCP message to acquire parameters such as the local address and the default router address.

In view of the issues described above, an object of the present invention is to provide a relay apparatus, a communication network system, and a load distribution method that enable load distribution of routers such as LSN devices in a relay network provided by a communications carrier. Another object of the present invention is to use the plurality of routers including LSN devices efficiently by distributing sessions by the relay apparatus placed in the carrier's relay network, on the basis of numbers of sessions held by the routers including LSN devices.

In a first aspect of the present invention, a plurality of LSN devices that perform a NAT process on packets from subscribers, and a relay apparatus that relays communication among the LSN devices are provided. The relay apparatus includes a route control unit and an LSN session management unit. The route control unit searches through a routing table for route information of a packet, when the packet is received from a subscriber, by the transmission source IP address, the transmission destination IP address, the transmission source port number, and the transmission destination port number of the received packet, determines a transfer destination, and updates the routing table for the route information of the LSN device selected by the LSN session management unit. The LSN session management unit adds the numbers of sessions held by the LSN devices to an LSN session table at regular intervals and selects an LSN device holding the smallest number of sessions as the transfer destination with reference to the LSN session table when a packet about which information is not included in the routing table is received.

In a second aspect of the present invention, a plurality of LSN devices that perform a NAT process on packets from subscribers, and a relay apparatus that relays communication among the LSN devices are provided, and when packets come from the subscribers, a session load distribution method distributes sessions evenly among the LSN devices. The session load distribution method includes the following steps: acquiring the numbers of sessions held by the LSN devices, at regular intervals and updating an LSN session table accordingly; when a packet is received, searching through a routing table for route information of the received packet and determining whether a session has been allocated to an LSN device; if a session has not been allocated, selecting an LSN device that holds the smallest number of sessions, with reference to the LSN session table; and adding information of the newly allocated session to the routing table.

According to the first solving means of the present invention, there is provided a relay apparatus that relays communication between a plurality of routers and a subscriber in a communication network system that includes the plurality of routers and the relay apparatus, the plurality of routers performing network address translation on a packet from the subscriber, the relay apparatus comprising:

a routing table that stores combinations of a transmission source address, a transmission destination address, a transmission source port number, a transmission destination port number, and a transfer destination port;

a session table that stores combinations of an address of each router, the number of sessions held by the router, and a transfer destination port of the router;

a route control unit that performs a packet transfer process on a received packet in accordance with the routing table; and

a session management unit that adds the number of sessions held by each router to the session table and selects a transfer destination router for the received packet;

if the packet is received from the subscriber side, the route control unit searching through the routing table by the transmission source address, the transmission destination address, the transmission source port number, and the transmission destination port number of the received packet, and if corresponding data is found, transferring the packet to a corresponding transfer destination port;

if corresponding data is not found, the route control unit requesting the session management unit to select a router;

at the request to select a router by the route control unit, the session management unit referencing the session table, selecting a router that holds the smallest number of sessions or a router that holds a fewer number sessions than a predetermined threshold, as the transfer destination, and obtaining the transfer destination port;

the route control unit transferring the packet to the transfer destination port of the router selected by the session management unit and updating the routing table to have route information that includes the transfer destination port of the selected router.

According to the second solving means of the present invention, there is provided a communication network system that includes a plurality of routers that performs network address translation on a packet from a subscriber, and a relay apparatus that relays communication between the plurality of routers and the subscriber, the relay apparatus comprising:

a routing table that stores combinations of a transmission source address, a transmission destination address, a transmission source port number, a transmission destination port number, and a transfer destination port;

a session table that stores combinations of an address of each router, the number of sessions held by the router, and a transfer destination port of the router;

a route control unit that performs a packet transfer process on a received packet in accordance with the routing table; and

a session management unit that adds the number of sessions held by each router to the session table and selects a transfer destination router for the received packet;

if the packet is received from the subscriber side, the route control unit searching through the routing table by the transmission source address, the transmission destination address, the transmission source port number, and the transmission destination port number of the received packet, and if corresponding data is found, transferring the packet to a corresponding transfer destination port;

if corresponding data is not found, the route control unit requesting the session management unit to select a router;

at the request to select a router by the route control unit, the session management unit referencing the session table, selecting a router that holds the smallest number of sessions or a router that holds a fewer number sessions than a predetermined threshold, as the transfer destination, and obtaining the transfer destination port;

the route control unit transferring the packet to the transfer destination port of the router selected by the session management unit and updating the routing table to have route information that includes the transfer destination port of the selected router.

According to the third solving means of the present invention, there is provided a load distribution method in a communication network system that includes a plurality of routers that performs network address translation on a packet from a subscriber, and a relay apparatus that relays communication between the plurality of routers and the subscriber, the relay apparatus comprising:

a routing table that stores combinations of a transmission source address, a transmission destination address, a transmission source port number, a transmission destination port number, and a transfer destination port;

a session table that stores combinations of an address of each router, the number of sessions held by the router, and a transfer destination port of the router;

a route control unit that performs a packet transfer process on a received packet in accordance with the routing table; and

a session management unit that adds the number of sessions held by each router to the session table and selects a transfer destination router for the received packet;

the load distribution method which distributes sessions evenly among the plurality of routers when packets come from the subscriber, comprising steps of:

if the packet is received from the subscriber side, the route control unit searching through the routing table by the transmission source address, the transmission destination address, the transmission source port number, and the transmission destination port number of the received packet, and if corresponding data is found, transferring the packet to a corresponding transfer destination port;

if corresponding data is not found, the route control unit requesting the session management unit to select a router;

at the request to select a router by the route control unit, the session management unit referencing the session table, selecting a router that holds the smallest number of sessions or a router that holds a fewer number sessions than a predetermined threshold, as the transfer destination, and obtaining the transfer destination port;

the route control unit transferring the packet to the transfer destination port of the router selected by the session management unit and updating the routing table to have route information that includes the transfer destination port of the selected router.

According to the present invention, in a network system having routers such as a plurality of LSN devices, the routers can be used efficiently by distributing sessions evenly among the routers. The network system can be configured with a plurality of small NAT devices, without using large-scale LSN devices.

### BRIEF DESCRIPTION OF THE DRAWINGS

FIG. 1 is a conventional network configuration diagram.

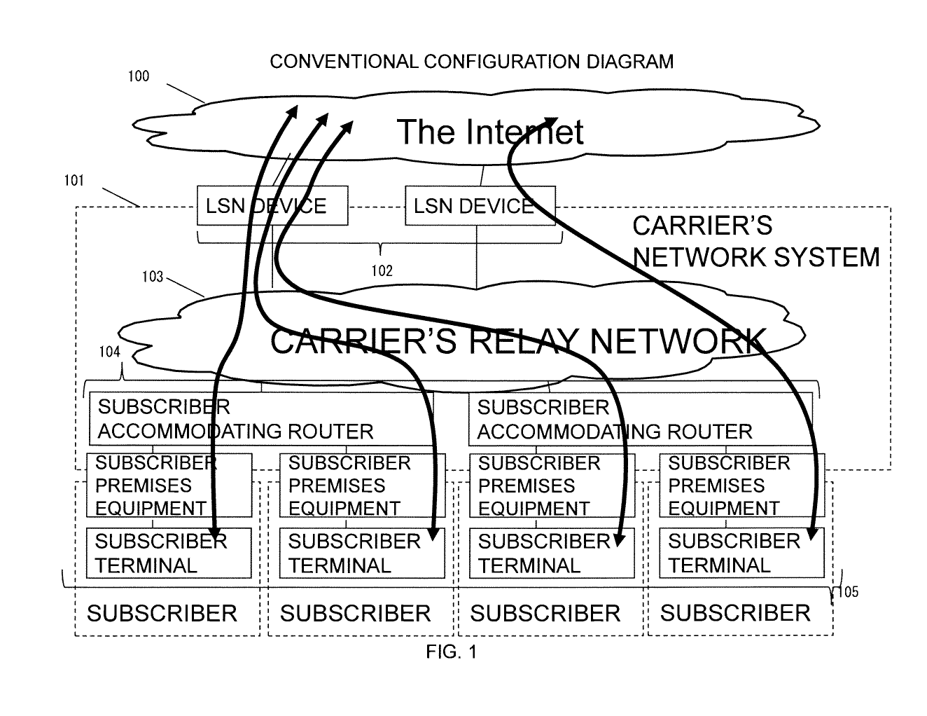

FIG. 2 is a network configuration diagram in an embodiment of the present invention.

FIG. 3 is a configuration diagram of a relay apparatus according to the embodiment.

FIG. 4 is a diagram showing the data structure of a routing table in the embodiment.

FIG. 5 is a diagram showing the data structure of an LSN session table in the embodiment.

FIG. 6 is a flowchart illustrating a packet reception process of a route control unit in the embodiment.

FIG. 7 is a flowchart illustrating a routing table update process of the route control unit in the embodiment.

FIG. 8 is a flowchart illustrating an LSN device selection process of an LSN session management unit in the embodiment.

FIG. 9 is a flowchart illustrating an LSN session table update process of the LSN session management unit in the embodiment.

### DESCRIPTION OF THE PREFERRED EMBODIMENTS

### 1. Configuration

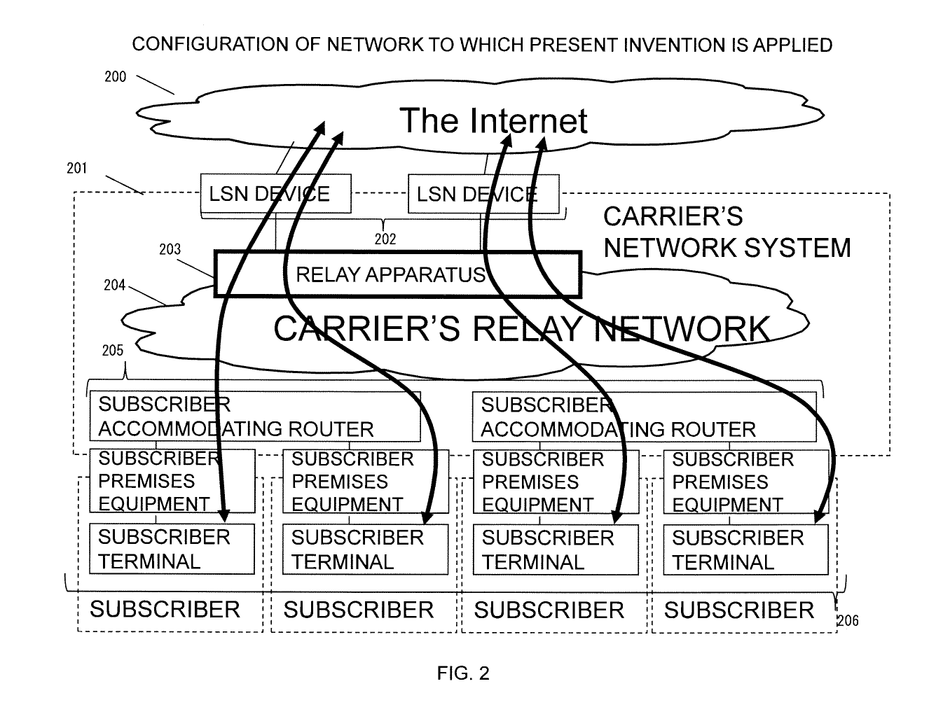

FIG. 2 is a configuration diagram of a network in an embodiment of the present invention.

A relay apparatus 203 (FIG. 2) according to this embodiment acquires the numbers of sessions held by a plurality of LSN devices 202 (FIG. 2) in the network at regular intervals. When a packet is received from a subscriber, the relay apparatus allocates the packet sent from the subscriber to an LSN device 202 (FIG. 2) that holds the smallest number of sessions or to an LSN device 202 (FIG. 2) that holds a fewer number of sessions than a predetermined threshold, thereby distributing session loads among the LSN devices 202 (FIG. 2).

For example, the relay apparatus 203 (FIG. 2) relays communication to the LSN devices 202 (FIG. 2) that perform a NAT process on packets from subscribers, and includes an LSN session management unit and a route control unit. The LSN session management unit acquires session information held by each LSN device 202 (FIG. 2) and selects one connection destination LSN device 202 (FIG. 2) for a received packet. The route control unit applies a transfer process to the received packet in accordance with a routing table.

The route control unit checks whether packet information of the packet received from the subscriber is included in the routing table, by the transmission source IP address, the transmission destination IP address, the transmission source port number, and the transmission destination port number of the packet. If the packet information is included in the routing table, the route control unit performs the transfer process according to the routing table. If not, the route control unit asks the LSN session management unit to select the LSN device 202 (FIG. 2) to be connected, and adds the route information of the LSN device 202 (FIG. 2) selected by the LSN session management unit to the routing table. The LSN session management unit updates the information of an LSN session table on a regular basis and selects the LSN device 202 (FIG. 2) to be connected.

The relay apparatus 203 (FIG. 2) includes the routing table and the LSN session table, which lists the numbers of sessions held by the LSN devices 202 (FIG. 2).

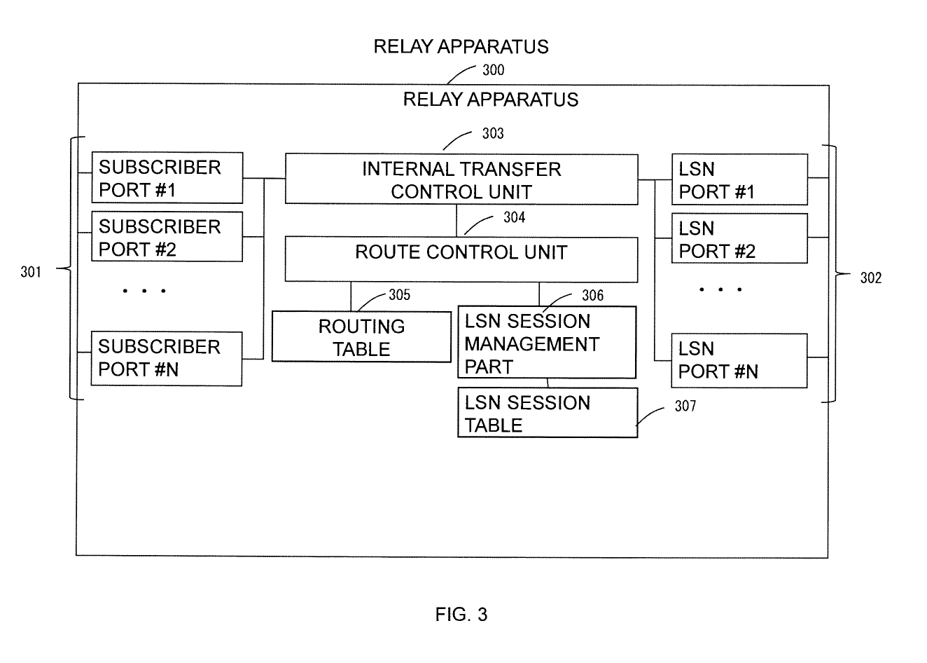

FIG. 3 is a configuration diagram of a relay apparatus according to the embodiment.

The relay apparatus 300 (FIG. 3) includes a plurality of subscriber ports 301 (FIG. 3) that perform communication with a plurality of pieces of subscriber premises equipment 206 (FIG. 2); a plurality of LSN ports 302 (FIG. 3) that perform communication with a plurality of LSN devices 202 (FIG. 2); an internal transfer control unit 303 (FIG. 3) that performs a packet transfer process to each port; a routing table 305 (FIG. 3) that contains a transmission source IP address with a network mask, a transmission destination IP address with a network mask, a transmission source port number, a transmission destination port number, a transfer destination port, and a route duration period (seconds); a route control unit 304 (FIG. 3) that searches through the routing table 305 (FIG. 3) for routing information of a received packet, determines the transfer destination of the packet, and updates the routing table 305 (FIG. 3) accordingly; an LSN session table 307 (FIG. 3) that contains the IP address of each LSN device 202 (FIG. 2), the numbers of sessions held by each LSN device, and a transfer destination port; and an LSN session management unit 306 (FIG. 3) that selects an LSN device 202 (FIG. 2) to which a received packet is sent at the request of the route control unit 304 (FIG. 3), with reference to the LSN session table 307 (FIG. 3).

A subscriber 206 (FIG. 2) uses an ADSL or FTTH service by utilizing the subscriber premises equipment on a par with a broadband router.

The relay apparatus 300 (FIG. 3) and the LSN devices 202 (FIG. 2) are routers disposed in a carrier's network system 201 (FIG. 2) and provide internet access services to the subscribers 206 (FIG. 2). The LSN devices 202 (FIG. 2) perform a NAT process on packets received from the subscribers 206 (FIG. 2).

The subscriber ports 301 (FIG. 3) are communication interfaces to the subscribers 206 (FIG. 2) in the carrier's network system 201 (FIG. 2). The LSN ports 302 (FIG. 3) are communication interfaces to the LSN devices 202 (FIG. 2) in the carrier's network system 201 (FIG. 2). Packet communication is performed through the subscriber ports 301 (FIG. 3) and the LSN ports 302 (FIG. 3). The subscriber ports 301 (FIG. 3) and the LSN ports 302 (FIG. 3) need not be connected directly to the subscribers 206 (FIG. 2) and the LSN devices 202 (FIG. 2), respectively, and they may be connected through other relay apparatuses such as routers 205 (FIG. 2) serving the subscribers.

The internal transfer control unit 303 (FIG. 3) transfers the packet received from the subscriber port 301 (FIG. 3) or the LSN port 302 (FIG. 3) to another subscriber port 301 (FIG. 3) or another LSN port 302 (FIG. 3) in accordance with an instruction from the route control unit 304 (FIG. 3).

The route control unit 304 (FIG. 3) updates the routing table 305 (FIG. 3) as specified by the routing protocol or the maintenance operator, searches through the routing table 305 (FIG. 3) for information of the packet received from the internal transfer control unit 303 (FIG. 3) by its IP header information, and determines the transfer destination port. If the transfer destination of the packet received from the subscriber port 301 (FIG. 3) is not included in the routing table, the route control unit 304 (FIG. 3) asks the LSN session management unit 306 (FIG. 3) to select an LSN device, determines the transfer destination on the basis of the destination port reported from the LSN session management unit 306 (FIG. 3), and updates the routing table accordingly.

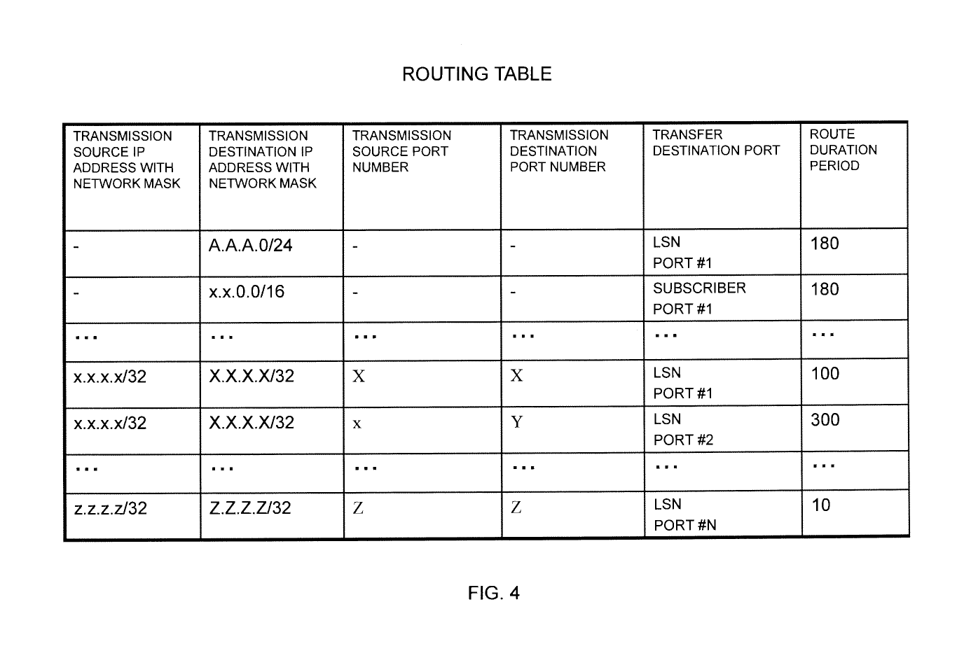

FIG. 4 shows the data structure of the routing table 305 (FIG. 3).

The routing table 305 (FIG. 3) is a database storing combinations of items used by the route control unit 304 (FIG. 3) to determine a transfer destination port. Those items include a transmission source address with a network mask, a transmission destination address with a network mask, a transmission source port number, a transmission destination port number, a transfer destination port, and a route duration period (seconds, for example). The database is updated at a variety of timings, such as when a route is learned by the routing protocol, when a route is specified by the maintenance operator, when the LSN session management unit 306 (FIG. 3) selects an LSN device 202 (FIG. 2) for a received packet, and when a given period has elapsed from when the LSN device 202 (FIG. 2) is allocated to the received packet.

The LSN session management unit 306 (FIG. 3) acquires the numbers of sessions held by the LSN devices 202 (FIG. 2) in the carrier's network system 201 (FIG. 2) at regular intervals, by the simple network management protocol (SNMP) or the like, and updates the LSN session table 307 (FIG. 3). At the request of the route control unit 304 (FIG. 3), the LSN session management unit 306 (FIG. 3) selects the LSN device that holds the smallest number of sessions as the LSN device to which the received packet should be sent, with reference to the LSN session table 307 (FIG. 3).

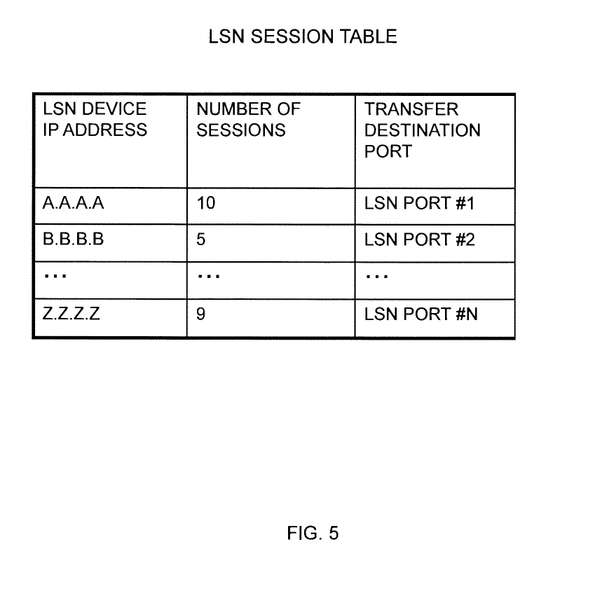

FIG. 5 shows the data structure of the LSN session table 307 (FIG. 3).

The LSN session table 307 (FIG. 3) is a database storing combinations of the IP address of each LSN device, the number of sessions held by the LSN device, and the transfer destination port, and is used when the LSN session management unit 306 (FIG. 3) selects the LSN device to be connected. The IP address of each LSN device is used to identify and access the LSN device; the number of sessions indicates the number of sessions held by each LSN device; and the transfer destination port indicates the LSN port to which the LSN device is connected. The database is updated at a timing when the LSN session management unit 306 (FIG. 3) acquires information from the LSN devices 202 (FIG. 2) at regular intervals, for example.

### 2. Processes

### 2.1 Reception Process

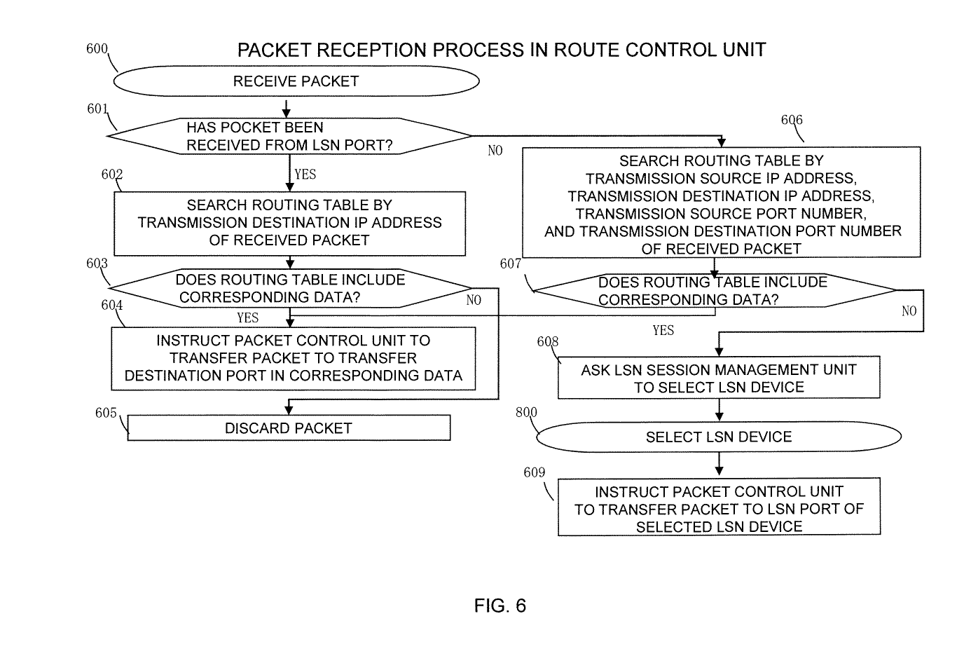

FIG. 6 is a flowchart illustrating a packet reception process of the route control unit 304 (FIG. 3) in this embodiment.

When a packet is received from the internal transfer control unit 303 (FIG. 3) (step 600), the route control unit 304 (FIG. 3) determines whether the packet has come from the LSN port 302 (FIG. 3) (step 601).

If the packet has been received from the LSN port 302 (FIG. 3) (Yes in step 601), the routing table 305 (FIG. 3) is searched by the destination IP address of the received packet (step 602). If the corresponding data is found in the routing table 305 (FIG. 3) (Yes in step 603), an instruction to transfer the packet to the corresponding transfer destination port is given to the internal transfer control unit 303 (FIG. 3) (step 604). If the corresponding data is not found in the routing table 305 (FIG. 3) (No in step 603), the received packet is discarded (step 605).

If the packet has been received from the subscriber port 301 (FIG. 3) (No in step 601), the routing table 305 (FIG. 3) is searched by the transmission source IP address, the transmission destination IP address, the transmission source port number, and the transmission destination port number of the received packet (step 606). If the corresponding data is found in the routing table 305 (FIG. 3) (Yes in step 607), an instruction to transfer the packet to the corresponding transfer destination port is given to the internal transfer control unit 303 (FIG. 3) (step 604). If the corresponding data is not found in the routing table 305 (FIG. 3), the packet is determined to be a packet unallocated to any LSN device, and the LSN session management unit 306 (FIG. 3) is asked to select an LSN device (step 608). After the LSN session management unit 306 (FIG. 3) selects an LSN device (step 800), the internal transfer control unit 303 (FIG. 3) is instructed to transfer the packet to the transfer destination port of the LSN device selected by the LSN session management unit 306 (FIG. 3) (step 609).

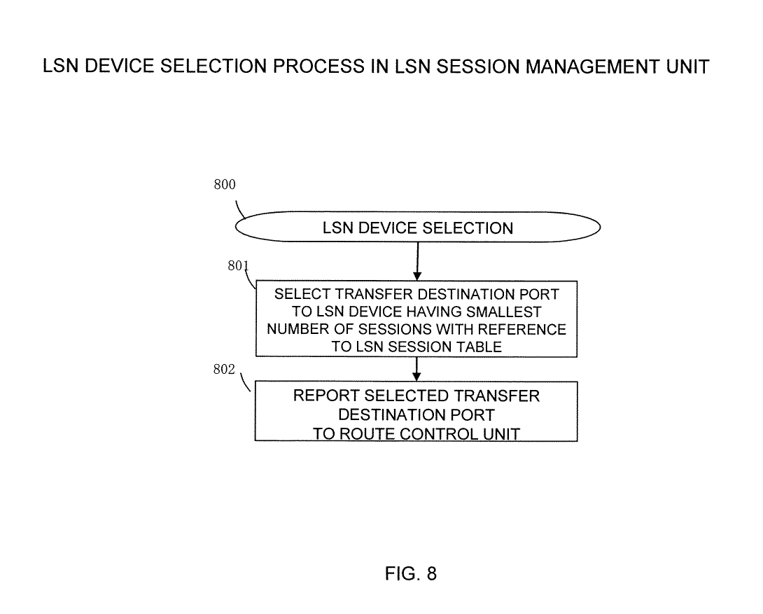

FIG. 8 is a flowchart illustrating an LSN device selection process in the LSN session management unit 306 (FIG. 3) in this embodiment.

At the request of the route control unit 304 (FIG. 3) (step 800), the LSN session management unit 306 (FIG. 3) selects the transfer destination port of an LSN device having the smallest number of sessions with reference to the LSN session table 307 (FIG. 3), as the transfer destination of the received packet (step 801). The transfer destination port of an LSN device having a fewer number of sessions than a predetermined threshold may be selected.

The selected transfer destination port is reported to the route control unit 304 (FIG. 3).

2.2 Update process

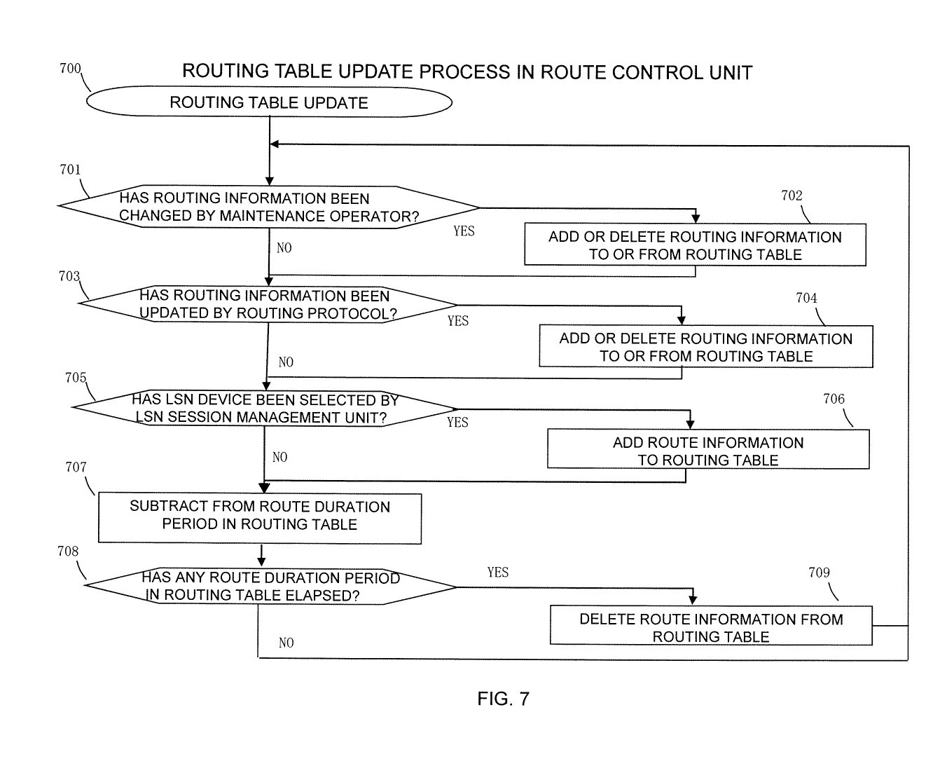

FIG. 7 is a flowchart illustrating a process to update the routing table 305 (FIG. 3) by the route control unit 304 (FIG. 3) in this embodiment.

The route control unit 304 (FIG. 3) checks whether the routing table includes information related to route information (a transmission source IP address with a network mask, a transmission destination IP address with a network mask, a transmission source port number, a transmission destination port number, a transfer destination port, and a route duration period (seconds)) specified by the maintenance operator (step 701). If the routing table includes information related to the route information specified by the maintenance operator (Yes in step 701), the specified route information (the transmission source IP address with the network mask, the transmission destination IP address with the network mask, the transmission source port number, the transmission destination port number, the transfer destination port, and the route duration period (seconds)) is added to or deleted from the routing table 305 (FIG. 3) (step 702).

If the routing table does not include information related to the route information specified by the maintenance operator (No in step 701) or after the routing table is updated (step 702), the route control unit 304 (FIG. 3) checks whether there is route information learned by a variety of predetermined routing protocols such as the dynamic routing protocol (step 703). If a route information update message of a routing protocol has been received and if there is learned route information to be added or deleted (Yes in step 703), the route information (a transmission destination IP address with a network mask, a transfer destination port, and a route duration period (seconds)) is added to or deleted from the routing table 305 (FIG. 3) (step 704).

Next, if there is no route information newly learned by a routing protocol (No in step 703) or after the routing table is updated (step 704), the route control unit 304 (FIG. 3) judges whether the LSN session management unit has selected an LSN device (step 705). If the LSN session management unit has selected an LSN device (yes in step 705), the routing information (a transmission source IP address with a network mask, a transmission destination IP address with a network mask, a transmission source port number, a transmission destination port number, a transfer destination port, and a route duration period (seconds)) of the LSN device is added to the routing table 305 (FIG. 3) (step 706). The judgment in step 705 can be made at intervals or at a timing in which the routing table update process is performed or at predetermined intervals or at a predetermined timing. A flag indicating whether an LSN device has been selected may be provided, and the judgment may be made with reference to the flag.

A predetermined period is subtracted from the route duration period (seconds) in the routing table 305 (FIG. 3) (step 707), and it is checked whether the duration period of any route has elapsed (step 708). If any route duration period has elapsed (being zero or a negative value, in this example), the corresponding route information is deleted from the routing table 305 (FIG. 3) (step 709).

If no the route duration period (seconds) has elapsed (No in step 707) or after a route has been deleted from the routing table (step 708), the process returns to step 701.

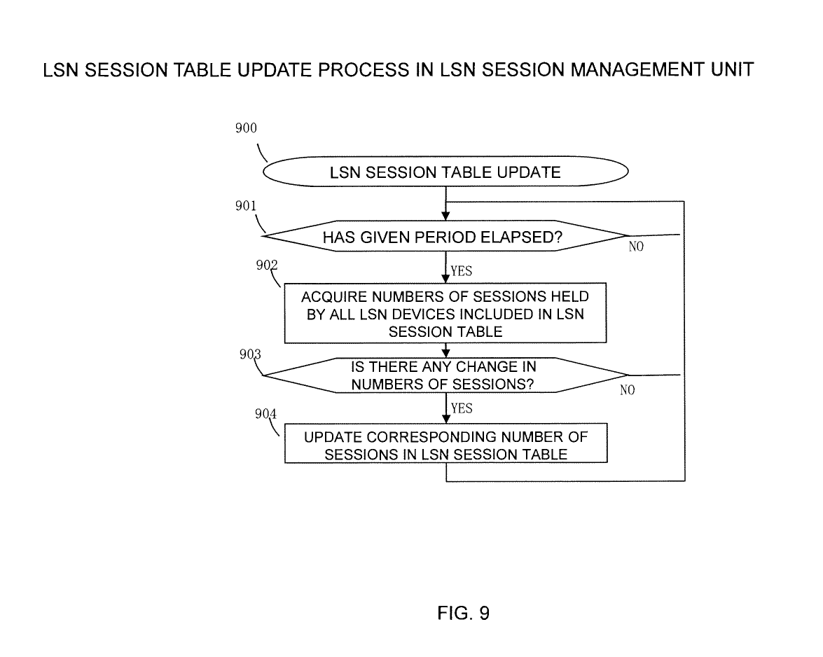

FIG. 9 is a flowchart illustrating a process of updating the LSN session table 307 (FIG. 3) by the LSN session management unit 306 (FIG. 3) in this embodiment.

To acquire session information from the LSN devices at regular intervals, the LSN session management unit 306 (FIG. 3) first checks whether a given period has elapsed (step 901). If the given period has elapsed (yes in step 901), the LSN session management unit 306 (FIG. 3) acquires the number of sessions at the IP address of each LSN device from the LSN session table 307 (FIG. 3) (step 902).

The LSN session management unit 306 (FIG. 3) checks whether there is a change in the numbers of sessions (step 903). If there is a change (yes in step 903), the corresponding number of sessions of the LSN device is updated to the acquired value (step 904). If there is no change in the numbers of sessions (No in step 903) or after the session table is updated (step 904), the process returns to step 901.

The present invention can be applied to a relay apparatus in a network system that includes a plurality of LSN devices, for example.

What is claimed is:

1. A relay apparatus that relays communication between a plurality of routers and a subscriber in a communication network system that includes the plurality of routers and the relay apparatus, the plurality of routers performing network address translation on a packet from the subscriber, the relay apparatus comprising:
a routing table that stores combinations of a transmission source address, a transmission destination address, a transmission source port number, a transmission destination port number, and a transfer destination port;
a session table that stores combinations of an address of each router, the number of sessions held by the router, and a transfer destination port of the router;
a route control unit that performs a packet transfer process on a received packet in accordance with the routing table; and
a session management unit that adds the number of sessions held by each router to the session table and selects a transfer destination router for the received packet;
if the packet is received from the subscriber side, the route control unit searching through the routing table by the transmission source address, the transmission destination address, the transmission source port number, and the transmission destination port number of the received packet, and if corresponding data is found, transferring the packet to a corresponding transfer destination port;
if corresponding data is not found, the route control unit requesting the session management unit to select a router;
at the request to select a router by the route control unit, the session management unit referencing the session table, selecting a router that holds the smallest number of sessions or a router that holds a fewer number sessions than a predetermined threshold, as the transfer destination, and obtaining the transfer destination port;
the route control unit transferring the packet to the transfer destination port of the router selected by the session management unit and updating the routing table to have route information that includes the transfer destination port of the selected router.

2. A relay apparatus according to claim 1, wherein
the route control unit determines whether the packet has been received from a port on the router side or from a port on the subscriber side;
if the packet has been received from the port on the router side, the route control unit searches the routing table by using the transmission destination address of the received packet, and transfers the packet to a corresponding transfer destination port; and
if corresponding data is not found in the routing table, the route control unit discards the received packet.

3. A relay apparatus according to claim 1, wherein the routing table further includes a route duration period for each data item; and
the route control unit judges whether the session management unit has selected a router;
if the session management unit has selected a router, the route control unit adds route information related to the router, including the transmission source address, the transmission destination address, the transmission source port number, the transmission destination port number, the transfer destination port, and the route duration period; and
the route control unit subtracts from the route duration period of the route information, and if a predetermined route duration period of any route has elapsed, deletes the route information from the routing table.

4. A relay apparatus according to claim 3, wherein the route control unit adds the route information to the routing table or deletes the route information from the routing table, in accordance with route information specified by a maintenance operator, and
the route control unit adds the learned route information to the routing table or deletes the learned route information from the routing table, in accordance with route information learned by a predetermined routing protocol.

5. A relay apparatus according to claim 1, wherein the session management unit acquires the number of sessions at the address of each router in the session table after a predetermined period has elapsed ; and
the session management unit judges whether the number of session has changed, and, if a change is found, updates the number of sessions of the router to the acquired value.

6. A relay apparatus according to claim 1, wherein the transmission source address and/or the transmission destination address includes a network mask.

7. A communication network system that includes a plurality of routers that performs network address translation on a packet from a subscriber, and a relay apparatus that relays communication between the plurality of routers and the subscriber, the relay apparatus comprising:
a routing table that stores combinations of a transmission source address, a transmission destination address, a transmission source port number, a transmission destination port number, and a transfer destination port;
a session table that stores combinations of an address of each router, the number of sessions held by the router, and a transfer destination port of the router;
a route control unit that performs a packet transfer process on a received packet in accordance with the routing table; and
a session management unit that adds the number of sessions held by each router to the session table and selects a transfer destination router for the received packet;
if the packet is received from the subscriber side, the route control unit searching through the routing table by the transmission source address, the transmission destination address, the transmission source port number, and the transmission destination port number of the received packet, and if corresponding data is found, transferring the packet to a corresponding transfer destination port;
if corresponding data is not found, the route control unit requesting the session management unit to select a router;
at the request to select a router by the route control unit, the session management unit referencing the session table, selecting a router that holds the smallest number of sessions or a router that holds a fewer number sessions than a predetermined threshold, as the transfer destination, and obtaining the transfer destination port;
the route control unit transferring the packet to the transfer destination port of the router selected by the session management unit and updating the routing table to have route information that includes the transfer destination port of the selected router.

8. A communication network system according to claim 7, wherein
the route control unit determines whether the packet has been received from a port on the router side or from a port on the subscriber side;
if the packet has been received from the port on the router side, the route control unit searches the routing table by using the transmission destination address of the received packet, and transfers the packet to a corresponding transfer destination port; and
if corresponding data is not found in the routing table, the route control unit discards the received packet.

9. A load distribution method in a communication network system that includes a plurality of routers that performs network address translation on a packet from a subscriber, and a relay apparatus that relays communication between the plurality of routers and the subscriber, the relay apparatus comprising:
a routing table that stores combinations of a transmission source address, a transmission destination address, a transmission source port number, a transmission destination port number, and a transfer destination port;
a session table that stores combinations of an address of each router, the number of sessions held by the router, and a transfer destination port of the router;
a route control unit that performs a packet transfer process on a received packet in accordance with the routing table; and
a session management unit that adds the number of sessions held by each router to the session table and selects a transfer destination router for the received packet;
the load distribution method which distributes sessions evenly among the plurality of routers when packets come from the subscriber, comprising steps of:
if the packet is received from the subscriber side, the route control unit searching through the routing table by the transmission source address, the transmission destination address, the transmission source port number, and the transmission destination port number of the received packet, and if corresponding data is found, transferring the packet to a corresponding transfer destination port;
if corresponding data is not found, the route control unit requesting the session management unit to select a router;
at the request to select a router by the route control unit, the session management unit referencing the session table, selecting a router that holds the smallest number of sessions or a router that holds a fewer number sessions than a predetermined threshold, as the transfer destination, and obtaining the transfer destination port;
the route control unit transferring the packet to the transfer destination port of the router selected by the session management unit and updating the routing table to have route information that includes the transfer destination port of the selected router.

10. A load distribution method according to claim 9, wherein
the route control unit determines whether the packet has been received from a port on the router side or from a port on the subscriber side;
if the packet has been received from the port on the router side, the route control unit searches the routing table by using the transmission destination address of the received packet, and transfers the packet to a corresponding transfer destination port; and
if corresponding data is not found in the routing table, the route control unit discards the received packet.
